(19) United States
(12) Patent Application Publication
(10) Pub. No.: US 2023/0072297 A1
(43) Pub. Date: Mar. 9, 2023

(54) KNOWLEDGE GRAPH BASED REASONING RECOMMENDATION SYSTEM AND METHOD

(71) Applicant: Accenture Global Solutions Limited, Dublin (IE)

(72) Inventors: Subhashini Lakshminarayanan, Chennai (IN); Gopali Raval Contractor, Mumbai (IN); Rajashree Chandrashekar, Bengaluru (IN)

(21) Appl. No.: 17/461,232

(22) Filed: Aug. 30, 2021

(51) Int. Cl. G06Q 50/18; G06F 40/279; G06N 5/04

(52) U.S. Cl. CPC G06Q 50/18; G06F 40/279; G06N 5/04

(57) ABSTRACT

A knowledge graph based reasoning recommendation system and method may analyze past concluded legal cases to find patterns and predict the outcomes of new legal cases before or during litigation. These patterns and outcomes may be used to determine a recommendation for a legal strategy. Input documents and/or enterprise claim data from past concluded cases may be combined and processed to calculate an association rule for the legal outcome associated with one or more of the claim type, counsel, and judge for the group of similar cases based on the analysis of individual cases within the group. Features extracted from the input documents from the past concluded cases and the calculated association rules may be incorporated into a knowledge graph, along with features extracted from input documents from new legal cases. A Policy-Guided Path Reasoning (PGPR) may be applied over the knowledge graph to calculate which legal strategy to recommend. The recommended legal strategy, as well as the reasoning for recommending the legal strategy may be displayed to a user.

### TECHNICAL FIELD

The present disclosure generally relates to a system and method for a recommendation system and method. More specifically, the present disclosure generally relates to a knowledge graph based reasoning recommendation system and method.

### BACKGROUND

In certain industries, a significant portion of a company's loss expense ratio goes to defending disputed legal claims. Claims that involve an attorney often double the settlement amount. In the industry of insurance, for example, this increase in settlement amount significantly increases insurers' expenses. Decision makers often rely on “gut feelings” or memories of adjusters and/or attorneys when determining how to litigate a legal claim (e.g., an insurance claim). This basis for making decisions can be quite flawed due to bias and inaccurate and/or fading memories. This basis additionally does not work when the people involved in past legal claims are no longer available.

Most artificial intelligence based applications are chatbots for scheduling appointments and providing frequently asked questions (FAQs) on processes. These artificial intelligence based applications do not analyze past court cases and/or provide recommendations for legal strategies.

There is a need in the art for a system and method that addresses the shortcomings discussed above.

### SUMMARY

A knowledge graph based reasoning recommendation system and method may analyze past concluded legal cases to find patterns and predict the outcomes of new legal cases before or during litigation. Input documents from past concluded cases and/or enterprise claim data may be processed to extract features characterizing past cases. The features from the past cases may be processed through a machine learning model to detect and group similar past concluded cases. The groups of similar past concluded cases may be processed through a legal outcome association rule learning engine to calculate an association rule for the legal outcome associated with one or more of the claim type, counsel, and judge for the group of similar cases based on the analysis of individual cases within the group. The extracted features from the input documents and/or enterprise claim data from the past concluded legal cases and the calculated association rules, as well as extracted features from the input documents from new legal cases, may be incorporated into a knowledge graph, along with features extracted from input documents related to new legal cases. A Policy-Guided Path Reasoning (PGPR) may be applied over the knowledge graph to calculate which legal strategy to recommend. The recommended legal strategy, as well as the reasoning for recommending the legal strategy, may be displayed to a user.

By processing input documents and/or enterprise claim data from past concluded cases to calculate an association rule for the legal outcome associated with one or more of the claim type, counsel, and judge for the group of similar cases based on the analysis of individual cases within the group, factors affecting outcomes may be objectively and accurately selected and the selection may be visibly supported by metrics, including support and lift related to association rules. By building a knowledge graph based on the features extracted from the set of past case documents and the calculated association rules as well as features extracted from the at least one new case document, Policy-Guided Path Reasoning (PGPR) may be applied to calculate a legal strategy to recommend, wherein the legal strategy includes at least a recommended counsel. With these features and association rules, PGPR can determine which factors have the most weight in determining the legal strategy that is most likely to result in a favorable outcome (e.g., judgment in favor of particular party or settling out of court). For example, the legal strategy may include settling a case before trial or for starting/continuing a trial with a particular attorney and/or claim strategy.

In one aspect, the disclosure provides a computer implemented method of applying knowledge graph based reasoning to recommend a legal strategy. The method may include receiving a set of past case documents characterizing past concluded legal cases and at least one new case document characterizing a new legal case. The method may include extracting, from the set of past case documents, features from each past case described in the documents including at least the legal outcome, the claim type, the counsel, and the judge corresponding to each past case. The method may include extracting, from the at least one new case document, features including at least the claim type. The method may include converting the features from the set of past case documents to a first set of embeddings. The method may include processing the first set of embeddings through a machine learning model to detect similar past cases and to assign the detected similar past cases to groups based on similarity. The method may include processing the features from the set of past cases in batches based on the assigned groups through an association rule module to calculate an association rule for the legal outcome associated with one or more of the claim type, counsel, and judge for each assigned group. The method may include generating an association rule index based on the calculated association rules. The method may include building a knowledge graph based on the features extracted from the set of past case documents and the calculated association rules as well as features extracted from the at least one new case document. The method may include applying Policy-Guided Path Reasoning (PGPR) over the knowledge graph to calculate a legal strategy to recommend, wherein the legal strategy includes at least a recommended counsel.

In yet another aspect, the disclosure provides a system for applying knowledge graph based reasoning to recommend a legal strategy, comprising one or more computers and one or more storage devices storing instructions that are operable, when executed by the one or more computers, to cause the one or more computers to: (1) receive a set of past case documents characterizing past concluded legal cases and at least one new case document characterizing a new legal case; (2) extract, from the set of past case documents, features from each past case described in the documents including at least the legal outcome, the claim type, the counsel, and the judge corresponding to each past case; (3) extract, from the at least one new case document, features including at least the claim type; (4) convert the features from the set of past case documents to a first set of embeddings; (5) process the first set of embeddings through a machine learning model to detect similar past cases and to assign the detected similar past cases to groups based on similarity; (6) process the features from the set of past cases in batches based on the assigned groups through an association rule module to calculate an association rule for the legal outcome associated with one or more of the claim type, counsel, and judge for each assigned group; (7) generate an association rule index based on the calculated association rules; (8) build a knowledge graph based on the features extracted from the set of past case documents and the calculated association rules as well as features extracted from the at least one new case document; and (9) apply Policy-Guided Path Reasoning (PGPR) over the knowledge graph to calculate a legal strategy to recommend, wherein the legal strategy includes at least a recommended counsel.

In yet another aspect, the disclosure provides a non-transitory computer-readable medium storing software comprising instructions executable by one or more computers which, upon such execution, cause the one or more computers to apply knowledge graph based reasoning to recommend a legal strategy by (1) receiving a set of past case documents characterizing past concluded legal cases and at least one new case document characterizing a new legal case; (2) extracting, from the set of past case documents, features from each past case described in the documents including at least the legal outcome, the claim type, the counsel, and the judge corresponding to each past case; (3) extracting, from the at least one new case document, features including at least the claim type; (4) converting the features from the set of past case documents to a first set of embeddings; (5) processing the first set of embeddings through a machine learning model to detect similar past cases and to assign the detected similar past cases to groups based on similarity; (6) processing the features from the set of past cases in batches based on the assigned groups through an association rule module to calculate an association rule for the legal outcome associated with one or more of the claim type, counsel, and judge for each assigned group; (7) generating an association rule index based on the calculated association rules; (8) building a knowledge graph based on the features extracted from the set of past case documents and the calculated association rules as well as features extracted from the at least one new case document; and (9) applying Policy-Guided Path Reasoning (PGPR) over the knowledge graph to calculate a legal strategy to recommend, wherein the legal strategy includes at least a recommended counsel.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a knowledge graph based reasoning recommendation system, according to an embodiment.

FIG. 2 shows overview of the disclosed method of applying knowledge graph based reasoning to recommend a legal strategy, according to an embodiment.

FIG. 3 shows a knowledge graph, according to an embodiment.

FIG. 4 shows examples of paths a reinforcement learning agent may sample, according to an embodiment.

FIGS. 5A and 5B shows a computer implemented method of applying knowledge graph based reasoning to recommend a legal strategy, according to an embodiment.

### DESCRIPTION OF EMBODIMENTS

The disclosed knowledge graph based reasoning recommendation system and method analyzes past concluded legal cases to find patterns and predict the outcomes of new legal cases before or during litigation. For example, the disclosed system and method may be used to determine recommendations for a legal strategy that may include settling a case before trial or for starting/continuing a trial with a particular attorney and/or claim strategy.

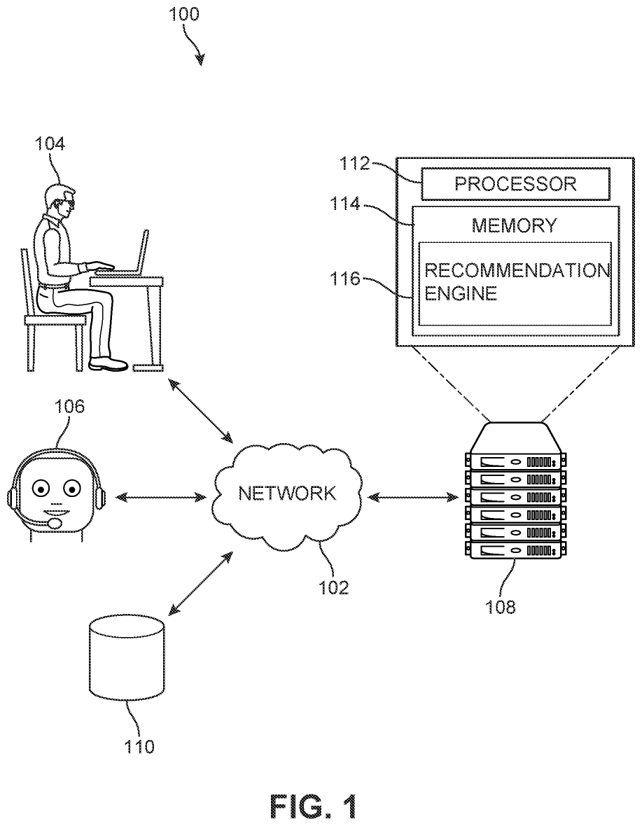

FIG. 1 is a schematic diagram of a knowledge graph based reasoning recommendation system 100 (or system 100), according to an embodiment. The disclosed system may include a plurality of components capable of performing the disclosed computer implemented method of applying knowledge graph based reasoning to recommend a legal strategy (e.g., method 200). For example, system 100 includes a first user device 104, a virtual agent 106, a computing system 108, a network 102, and a knowledge base 110. The components of system 100 can communicate with each other through network 102. For example, first user 104 may communicate with virtual agent 106 via network 102. In some embodiments, network 102 may be a wide area network (“WAN”), e.g., the Internet. In other embodiments, network 102 may be a local area network (“LAN”).

As shown in FIG. 1, a recommendation engine 116 may be hosted in computing system 108, which may have a memory 114 and a processor 112. Processor 112 may include a single device processor located on a single device, or it may include multiple device processors located on one or more physical devices. Memory 114 may include any type of storage, which may be physically located on one physical device, or on multiple physical devices. In some cases, computing system 108 may comprise one or more servers that are used to host recommendation engine 116. Database 110 may store data that may be retrieved by other components for system 100.

While FIG. 1 shows a single user device, it is understood that more user devices may be used. For example, in some embodiments, the system may include two or three user devices. The user may include an individual (e.g., an attorney) seeking guidance on how to proceed with a potential case (e.g., an insurance claim). In some embodiments, the user device may be a computing device used by a user. For example, first user device 104 may include a smartphone or a tablet computer. In other examples, first user device 104 may include a laptop computer, a desktop computer, and/or another type of computing device. The user devices may be used for inputting, processing, and displaying information. Virtual agent 106 may be a chatbot capable of communicating with first user device 104. For example, virtual agent 106 may conduct a chat with first user device 104 in which virtual agent 106 asks the user for information related to the user's potential case and responds to the user's utterances.

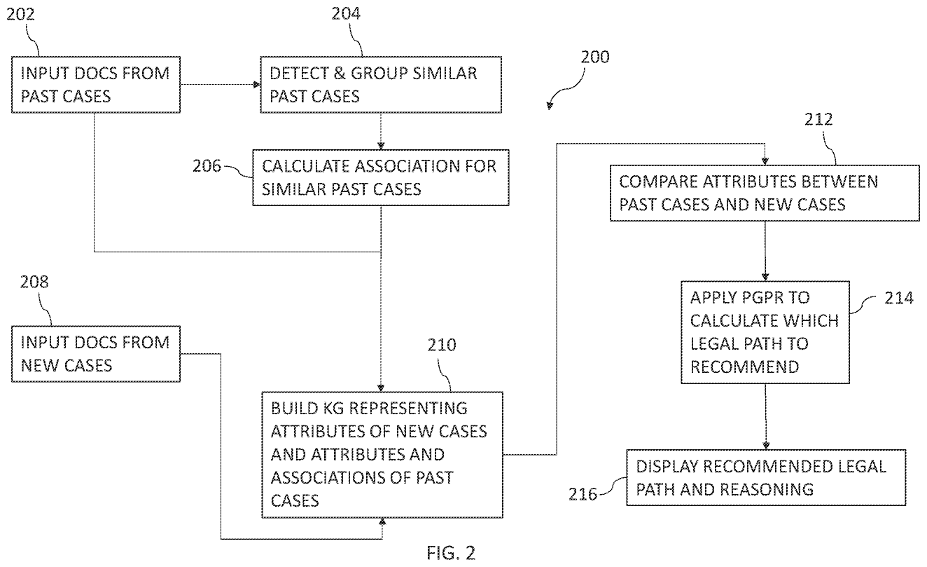

FIG. 2 shows an overview 200 of the disclosed method of applying knowledge graph based reasoning to recommend a legal strategy, according to an embodiment. Generally, at a high level, the disclosed method may include receiving input documents and/or enterprise claim data from past concluded cases (operation 202). These input documents and/or enterprise claim data may provide details characterizing the points of interest in past concluded cases. For example, these points of interest may include the type of loss, cause of loss, claim amount, legal counsel handling case, and/or judge name assigned to the case. The system and method may include applying natural language to extract features from these documents from past cases. The system and method may further include processing the details from the past cases through a machine learning model to detect and group similar past concluded cases (operation 204). The groups of similar past concluded cases may be processed through a legal outcome association rule learning engine to calculate an association rule for the legal outcome (e.g., judgment in favor of plaintiff or defendant or settlement) associated with one or more of the claim type, counsel, and judge for the group of similar cases based on the analysis of individual cases within the group (operation 206).

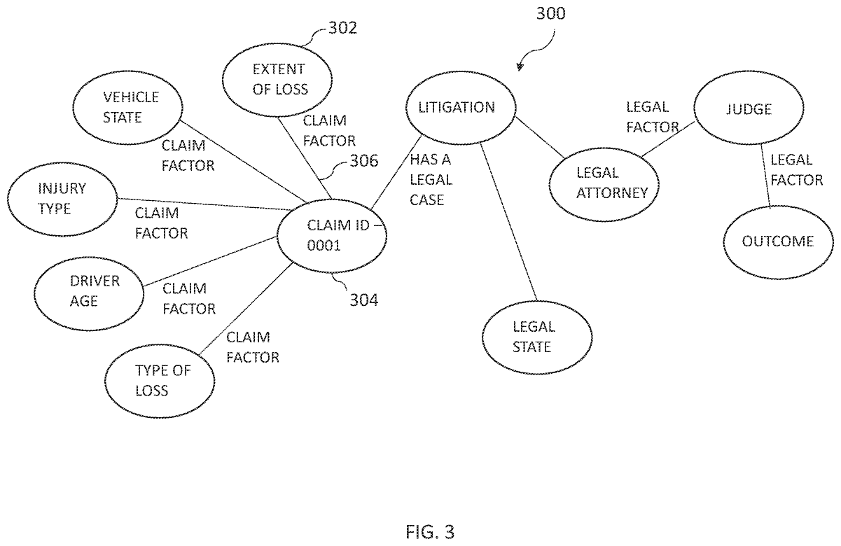

The disclosed system and method may include building a knowledge graph (operation 210). The extracted features from the input documents from past concluded cases and the calculated association rules may be incorporated into the knowledge graph as attributes represented by nodes. Additionally, as new cases (e.g., new claims that have yet to be litigated or new cases entering litigation) arise, details from input documents from the new cases (operation 208) may be extracted by natural language processing and incorporated into the knowledge graph as attributes represented by nodes. As shown in FIG. 3, the nodes in the knowledge graph may be connected by edges representing the relationship between the adjoining nodes.

Knowledge graphs are dynamic allowing for new information to be added in real time without constraints on the amount of information added. Knowledge graphs also store information in a structured manner that is easy to understand and lends itself to reinforcement learning.

The system and method may include comparing attributes between past concluded cases and new cases (operation 212). For example, attributes represented by the nodes of the knowledge graph in a new case may be compared with the same type of attributes in past cases. This comparison may be done for each new case.

The system and method may include applying Policy-Guided Path Reasoning (PGPR) over the knowledge graph to calculate which legal strategy to recommend (operation 214). The system and method may include displaying the recommended legal strategy, as well as the reasoning for recommending the legal strategy (operation 216).

As mentioned, the disclosed system and method may include receiving input documents and/or enterprise claim data from both past concluded legal cases and new legal cases. These input documents may be gathered from various sources and may include various types of information/details provided in various formats (i.e., structured or unstructured). For example, these documents may include documents with text describing and/or characterizing the following details: policy details, loss details, risk details, claim amount, liability details, customer details, evidence/assessment details, and/or subrogation details. In another example, the input documents and/or enterprise claim data from past concluded cases may additionally or alternatively include litigation demographics including claim amounts, case amounts, locations, property details, case types, and/or key dates. The input documents may include various types of documents. For example, documents, such as, claims adjuster notes, accident descriptions (e.g., identity and details of individuals and/or automobiles involved; dates and times of events), insurance policies, and/or police reports may provide information useful in analyzing past legal cases. The past concluded cases may include details related to the outcomes of the cases (e.g., judgment in favor of plaintiff or defendant or settlement). However, the new cases may not have outcomes to have details for, as these new cases have either not been initiated or have begun but have not concluded.

In some embodiments, rather than receiving and processing documents from new legal cases, the system and method may include providing other ways of gathering information about new legal cases. For example, the system may provide an interface where a user may submit new case information into a form (e.g., a form having fillable blanks and/or pulldown menus). In another example, a virtual agent may hold a session with a user in which the virtual agent prompts the user to enter new case information.

As previously mentioned, the system and method may further include processing the features extracted from the past concluded cases and/or enterprise claim data through a machine learning model to detect and group similar past concluded cases. The extracted features may be in the form of words and phrases. To make the extracted features easier to process, the words and phrases may be converted to word embeddings. Input documents containing structured text may be processed through predictive modeling/feature engineering to extract features and generate vector embeddings. Input documents may contain unstructured and/or narrative text. These types of documents may be processed applying pre-trained natural language processing models, such as LEGAL-BERT (an open source version of Bidirectional Encoder Representations from Transformers (BERT) meant for legal documents), to extract features and convert words and phrases characterizing features into vector embeddings. Once embeddings are generated from both types of documents, the embeddings for each feature of each individual past concluded case may be collated resulting in a single embedding representing the individual past concluded case. The embeddings for each past concluded case may be collated in this manner. Then, a self-organizing map (SOM) may be applied to the collated embeddings to identify clusters of similar cases (i.e., cases having similar characteristics). Similar cases may be placed in groups based on the identified clusters. Examples of characteristics or features considered when finding similar cases may include type of loss, cause of loss, claims amount, number of parties involved, number of persons injured, subrogation involved, case type, claim type, claim complexity, claim group, legal counsel (e.g., law firm and/or individual attorney), and/or judge name.

As previously mentioned, the system and method may further include processing the groups of similar past concluded cases through a legal outcome association rule learning model to calculate an association rule for the legal outcome associated with one or more of the claim type, counsel, and judge for the group of similar cases based on the analysis of individual cases within the group. For example, a legal outcome association rule learning model may be a rule-based machine learning model. An association rule can show a correlation between the claim type, counsel, and/or judge with the outcome. The disclosed system and method may further include building an association rule index organizing the association rules calculated. For example, an association rule index may contain a structure, such as a table, in which an antecedent, a corresponding consequent, support for each of the antecedent, and a lift ratio corresponding to each rule defined by the antecedent and consequent pair. Table 1 below shows an association rule index according to an embodiment. In Table 1, An represents claim type, Bn represents counsel, Cn represents judge, and Dn represents judge. Support indicates the frequency of an itemset (e.g., (A1, B1) or C1 for line 1 of Table 1) in a dataset. Lift ratio indicates the ratio of the observed support to that expected if the itemsets (e.g., (A1, B1) and C1 for line 1 of Table 1) were independent.

TABLE 1
Association Rule Index According to an Embodiment

| | | | | Support for | |
|---|---|---|---|---|---|
| | | Support for | Support for | Antecedent & | Lift |
| Antecedent | Consequent | Antecedent | Consequent | Consequent | Ratio |
| A1, B1 | C1 | 113 | 324 | 106 | 2.03 |
| A1, C1, D1 | B1 | 114 | 572 | 104 | 2.03 |
| A2, B2, C2 | B2 | 123 | 245 | 123 | 2.23 |
| A3, B2, C1 | D1 | 113 | 245 | 143 | 2.12 |

If the rule had a lift of 1, it would imply that the probability of occurrence of the antecedent and that of the consequent are independent of each other. When two events are independent of each other, no rule can be drawn involving those two events. A lift that is>1 indicates the degree to which those two occurrences are dependent on one another, and makes such rules potentially useful for predicting the consequent in future data sets. A lift that is<1 indicates that the items are substitutes for each other. This means that presence of one item has negative effect on presence of other item and vice versa. Lift considers both the support of the rule and the overall dataset.

As mentioned above, the disclosed system and method may include building a knowledge graph by generating nodes representing features (or attributes or details) extracted from the past concluded cases and the calculated association rules and generating edges defining the connections/relationship between features. Additionally, as new cases (e.g., new claims that have yet to be litigated or new cases entering litigation) arise, features from the new cases may be extracted by natural language processing and incorporated into the knowledge graph as features represented by nodes and edges may also be generated to define the relationship between nodes. In some embodiments, the knowledge graph may be built with the aid of a graph database management system, such as Neo4j, which is open source. FIG. 3 shows a knowledge graph 300, according to an embodiment. As shown in FIG. 3, the circles with words in them are nodes (e.g., a first node 302) and the lines connecting the circles are edges (e.g., a first edge 304). FIG. 3 shows a claim with an ID number of 0001. Claim factors for claim ID 0001 include “type of loss”, “driver age”, “injury type”, “vehicle state”, and “extent of loss”. Claim ID 0001 has a legal case with the attribute of “litigation,” which has its own attributes including “legal attorney” and “legal state.” The state of litigation may determine whether certain attributes are added. In this example, the “legal attorney” node is connected to the “judge” node with edge of “legal factor” and the “outcome” node is connected to “judge” by edge of “legal factor.”

As previously mentioned, the system and method may include comparing attributes (or features) between past concluded cases and new cases. Like attributes may be compared between cases. For example, a first type of attribute (e.g., case location) related to a first case may be compared with a first type of attribute (e.g., case location) related to a second case. To make these comparisons simpler to compare, the nodes of the knowledge graph may be converted into embeddings. For example, a machine learning model, such as graphSAGE (a model for inductive representation learning on large graphs), may be applied to compute embeddings for each node of the knowledge graph. Then, the similarity between each node may be found by calculating the first-order proximity between each node embedding. A proximity score may represent the weight of an edge between two nodes, which indicates the similarity of the nodes. This comparison between nodes may be done for each attribute of each new legal case against like attributes of past legal cases to help identify which past legal cases are most similar to the new legal cases.

As previously mentioned, the system and method may include applying Policy-Guided Path Reasoning (PGPR) over the knowledge graph to calculate which legal strategy to recommend. For example, in some embodiments, a 2-hop PGPR process may be applied. The basics of PGPR of described in Yikun Xian, Zuohui Fu, S. Muthukrishnan, Gerard de Melo, and Yongfeng Zhang, 2019, “Reinforcement Knowledge Graph Reasoning for Explainable Recommendation,” In Proceedings of the 42nd International ACM SIGIR, which is incorporated by reference in its entirety. In some embodiments, the system and method may include training a reinforcement learning agent to learn to navigate to potentially desirable items conditioned on the starting user in the knowledge graph environment. The reinforcement learning agent may then iteratively sample reasoning paths for each user leading to the recommended items. The reinforcement learning agent may iteratively correct until better recall and precision are achieved.

The paths sampled by the reinforcement learning agent may naturally serve as the explanations for the recommended items. Metrics used for PGPR may include Precision, Recall, Normalized Discounted Cumulation Gain (NDCG), and Hit Ratio (HR). Higher scores in the above metrics indicate better recommendation performance. Iteratively sampling paths may reveal that certain paths include a sequence of nodes that result in higher precision and recall compared with other paths. Table 2 below shows results for different history representations of state, according to an embodiment.

TABLE 2
Results for Different History Representations
of State, According to an Embodiment

| | Dataset | | | | | | | |
|---|---|---|---|---|---|---|---|---|
| | Judge Counsel Association Rule | | | | Litigation Outcomes | | | |
| History | NDCG | Recall | HR | Prec | NDCG | Recall | HR | Prec |
| 0 - step | 1.972 | 3.117 | 4.492 | 0.462 | 1.472 | 3.317 | 8.492 | 0.462 |
| 1 - step | 2.672 | 4.817 | 7.492 | 0.762 | 5.672 | 4.817 | 8.492 | 0.362 |
| 2 - step | 2.972 | 4.717 | 6.492 | 0.702 | 8.972 | 6.717 | 13.492 | 1.708 |

In Table 2, the numbers are percentages. 0-step means “no history”, 1-step means “last entity eₜ₋₁ with relation rₜ”, and 2-step means “two entities eₜ₋₂, eₜ₋₂ with relations rₜ₋₁, rₜ”. The system and method may recommend the path having the best combination of precision and recall of all of the paths sampled.

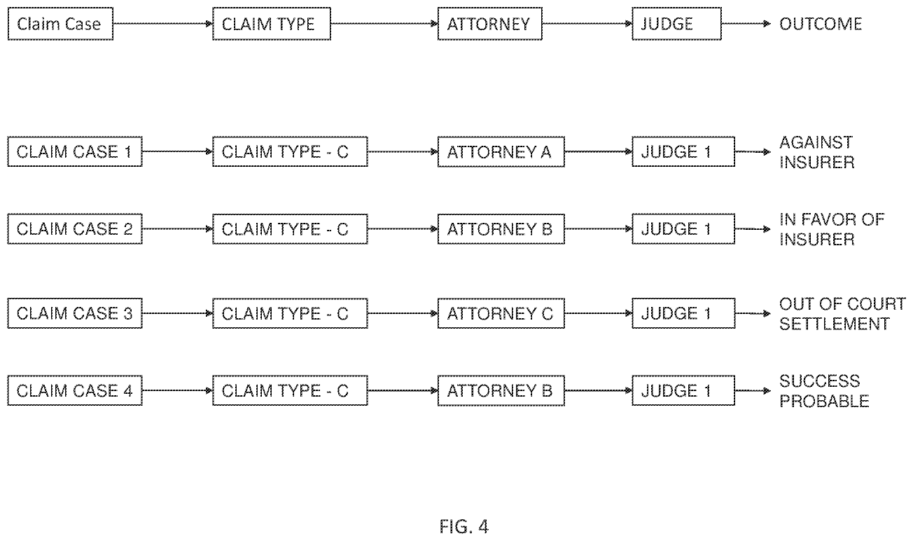

FIG. 4 shows examples of paths a reinforcement learning agent may sample, according to an embodiment. The pattern of paths may include “claim case”, “claim type”, “attorney”, and “judge” leading to an “outcome.” The paths of past cases containing claim case 1, claim case 2, and claim case 3 each have claim type C and judge 1. However, each of these paths has a different attorney and a different corresponding outcome. When comparing new case 4, which also has claim type C and judge 1, it is predicted that attorney B is the attorney that will most likely lead to a judgment in favor of the insurer based on the combination of claim type and judge, as well as outcomes from past cases. Accordingly, in some embodiments, the system would recommend attorney B for the insurer in this situation.

Table 3 below shows results for certain paths, according to an embodiment.

TABLE 3
Results for Certain Paths, According to an Embodiment

| Reasoning Paths | Recall | Precision |
|---|---|---|
| CT-CC-A-J-O | 8.117 | 1.462 |
| CT-CS-NP-A-J-O | 11.837 | 1.762 |
| CT-CS-CA-NP-A-J-O | 12.717 | 1.702 |
| CT-CS-CC-NP-A-J-O | 14.24 | 2.68 |

In Table 3, CT is “claim type, CC is claim complexity, CS is “claim severity”, A is “attorney”, J is “judge”, NP is “number of parties”, CA is “case amount”, and O is “outcome.”
In Table 3, the last path yields the best precision and recall, and would be the recommended path.

Finally, the system and method may include displaying the recommended legal strategy (or legal path), as well as the reasoning for recommending the legal strategy. In some embodiments, the recommended legal strategy may include a recommended attorney and judge pairing. For example, a judge may be set for the case, and the attorney may be the recommendation. The system and method may display the attorney and judge pairing, as well as the percent chance of the desired outcome (e.g., 75% win for insurer). In some embodiments, the system and method may include displaying the lift ratio of the association rule corresponding to the recommended path, which can provide reasoning for the recommendation and more context for making a decision about proceeding with a legal strategy. The system and method may also include displaying the worthiness of taking a claim to court, the estimated duration of litigating a claim (e.g., a long duration), or whether a case may be rejected in court for having insufficient details.

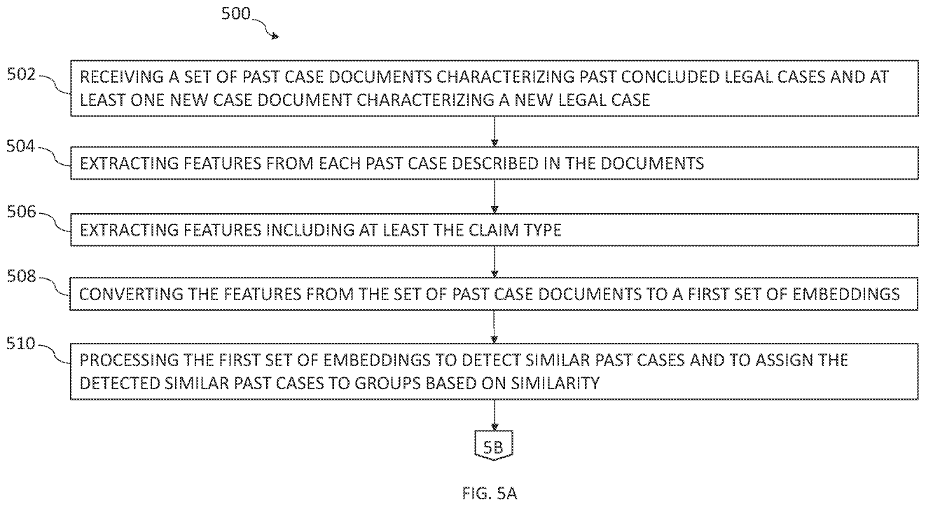

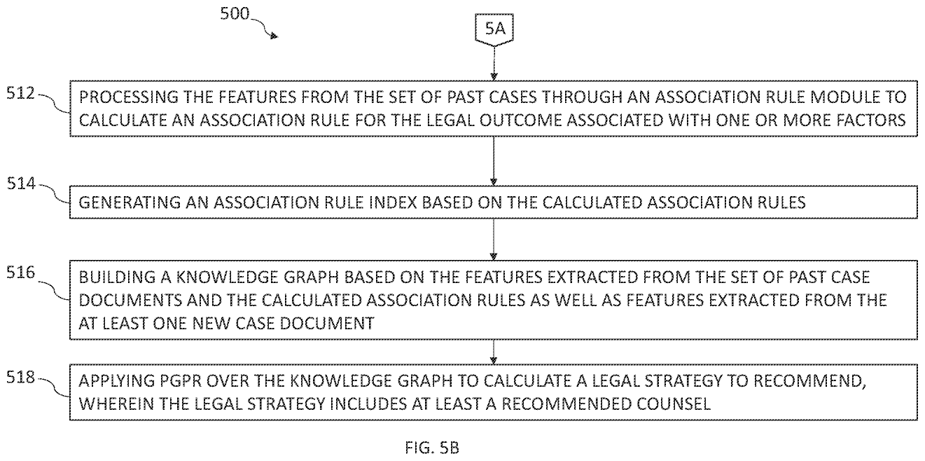

FIGS. 5A and 5B shows a computer implemented method of applying knowledge graph based reasoning to recommend a legal strategy 500 (or method 500), according to an embodiment. Method 500 provides more detail than overview 200 to demonstrate how the basic operations of overview 200 may be fleshed out according to an embodiment. Method 500 may include receiving a set of past case documents characterizing past concluded legal cases and at least one new case document characterizing a new legal case (operation 502). In some embodiments, instead of or in addition to input documents, the method may include receiving enterprise claim data or other claim data related to past or new legal cases.

Method 500 may include extracting, from the set of past case documents, features from each past case described in the documents including at least the legal outcome, the claim type, the counsel, and the judge corresponding to each past case (operation 504). Method 500 may include extracting, from the at least one new case document, features including at least the claim type (operation 506). Method 500 may include converting the features from the set of past case documents to a first set of embeddings (operation 508). Method 500 may include processing the first set of embeddings through a machine learning model to detect similar past cases and to assign the detected similar past cases to groups based on similarity (operation 510). Method 500 may include processing the features from the set of past cases in batches based on the assigned groups through an association rule module to calculate an association rule for the legal outcome associated with one or more of the claim type, counsel, and judge for each assigned group (operation 512). Method 500 may include generating an association rule index based on the calculated association rules (operation 514). Method 500 may include building a knowledge graph based on the features extracted from the set of past case documents and the calculated association rules as well as features extracted from the at least one new case document (operation 516). Method 500 may include applying Policy-Guided Path Reasoning (PGPR) over the knowledge graph to calculate a legal strategy to recommend, wherein the legal strategy includes at least a recommended counsel (operation 518).

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A computer implemented method of applying knowledge graph based reasoning to recommend a legal strategy, comprising:
receiving a set of past case documents characterizing past concluded legal cases and at least one new case document characterizing a new legal case;
extracting, from the set of past case documents, features from each past case described in the documents including at least the legal outcome, the claim type, the counsel, and the judge corresponding to each past case;
extracting, from the at least one new case document, features including at least the claim type;
converting the features from the set of past case documents to a first set of embeddings;
processing the first set of embeddings through a machine learning model to detect similar past cases and to assign the detected similar past cases to groups based on similarity;
processing the features from the set of past cases in batches based on the assigned groups through an association rule module to calculate an association rule for the legal outcome associated with one or more of the claim type, counsel, and judge for each assigned group;
generating an association rule index based on the calculated association rules;
building a knowledge graph based on the features extracted from the set of past case documents and the calculated association rules as well as features extracted from the at least one new case document; and
applying Policy-Guided Path Reasoning (PGPR) over the knowledge graph to calculate a legal strategy to recommend, wherein the legal strategy includes at least a recommended counsel.

2. The method of claim 1, wherein the method further includes displaying the recommended legal strategy, as well as the reasoning for recommending the legal strategy.

3. The method of claim 1, wherein the displayed reasoning includes the lift ratio of the association rule corresponding to the recommended path.

4. The method of claim 1, wherein the features extracted from the set of past case documents includes one or more of type of loss, extent of loss, vehicle state, injury type, driver age, and legal state.

5. The method of claim 4, wherein the features extracted from the at least one new case document includes one or more of type of loss, extent of loss, vehicle state, injury type, driver age, and legal state.

6. The method of claim 1, wherein processing the features from the set of past cases in batches based on the assigned groups through an association rule module results in calculating an association rule for the legal outcome associated with the claim type for each assigned group.

7. The method of claim 1, wherein processing the features from the set of past cases in batches based on the assigned groups through an association rule module results in calculating an association rule for the legal outcome associated with the counsel for each assigned group.

8. The method of claim 1, wherein processing the features from the set of past cases in batches based on the assigned groups through an association rule module results in calculating an association rule for the legal outcome associated with the judge for each assigned group.

9. A system for applying knowledge graph based reasoning to recommend a legal strategy, comprising:
one or more computers and one or more storage devices storing instructions that are operable, when executed by the one or more computers, to cause the one or more computers to:
receive a set of past case documents characterizing past concluded legal cases and at least one new case document characterizing a new legal case;
extract, from the set of past case documents, features from each past case described in the documents including at least the legal outcome, the claim type, the counsel, and the judge corresponding to each past case;
extract, from the at least one new case document, features including at least the claim type;
convert the features from the set of past case documents to a first set of embeddings;
process the first set of embeddings through a machine learning model to detect similar past cases and to assign the detected similar past cases to groups based on similarity;
process the features from the set of past cases in batches based on the assigned groups through an association rule module to calculate an association rule for the legal outcome associated with one or more of the claim type, counsel, and judge for each assigned group;
generate an association rule index based on the calculated association rules;
build a knowledge graph based on the features extracted from the set of past case documents and the calculated association rules as well as features extracted from the at least one new case document; and
apply Policy-Guided Path Reasoning (PGPR) over the knowledge graph to calculate a legal strategy to recommend, wherein the legal strategy includes at least a recommended counsel.

10. The system of claim 9, wherein the method further includes displaying the recommended legal strategy, as well as the reasoning for recommending the legal strategy.

11. The system of claim 10, wherein the displayed reasoning includes the lift ratio of the association rule corresponding to the recommended path.

12. The system of claim 9, wherein the features extracted from the set of past case documents includes one or more of type of loss, extent of loss, vehicle state, injury type, driver age, and legal state.

13. The system of claim 12, wherein the features extracted from the at least one new case document includes one or more of type of loss, extent of loss, vehicle state, injury type, driver age, and legal state.

14. The system of claim 9, wherein processing the features from the set of past cases in batches based on the assigned groups through an association rule module results in calculating an association rule for the legal outcome associated with the claim type for each assigned group.

15. The system of claim 9, wherein processing the features from the set of past cases in batches based on the assigned groups through an association rule module results in calculating an association rule for the legal outcome associated with the counsel for each assigned group.

16. The system of claim 9, wherein processing the features from the set of past cases in batches based on the assigned groups through an association rule module results in calculating an association rule for the legal outcome associated with the judge for each assigned group.

17. A non-transitory computer-readable medium storing software comprising instructions executable by one or more computers which, upon such execution, cause the one or more computers to apply knowledge graph based reasoning to recommend a legal strategy by:
receiving a set of past case documents characterizing past concluded legal cases and at least one new case document characterizing a new legal case;
extracting, from the set of past case documents, features from each past case described in the documents including at least the legal outcome, the claim type, the counsel, and the judge corresponding to each past case;
extracting, from the at least one new case document, features including at least the claim type;
converting the features from the set of past case documents to a first set of embeddings;
processing the first set of embeddings through a machine learning model to detect similar past cases and to assign the detected similar past cases to groups based on similarity;
processing the features from the set of past cases in batches based on the assigned groups through an association rule module to calculate an association rule for the legal outcome associated with one or more of the claim type, counsel, and judge for each assigned group;
generating an association rule index based on the calculated association rules;
building a knowledge graph based on the features extracted from the set of past case documents and the calculated association rules as well as features extracted from the at least one new case document; and
applying Policy-Guided Path Reasoning (PGPR) over the knowledge graph to calculate a legal strategy to recommend, wherein the legal strategy includes at least a recommended counsel.

18. The non-transitory computer-readable medium of claim 17, wherein the method further includes displaying the recommended legal strategy, as well as the reasoning for recommending the legal strategy.

19. The non-transitory computer-readable medium of claim 18, wherein the displayed reasoning includes the lift ratio of the association rule corresponding to the recommended path.

20. The non-transitory computer-readable medium of claim 18, wherein the features extracted from the set of past case documents includes one or more of type of loss, extent of loss, vehicle state, injury type, driver age, and legal state.
